(19) United States
(12) Patent Application Publication
(10) Pub. No.: US 2002/0070553 A1
(43) Pub. Date: Jun. 13, 2002

(54) Method and apparatus for an automatic horizontal movement of a movable object utilizing the gravitation force

(76) Inventor: Pichit Likitcheva, Bangkok (TH)

Correspondence Address: WILLIAM R. EVANS, LADAS & PARRY, 26 WEST 61ST STREET, NEW YORK, NY, 10023, US

(21) Appl. No.: 09/733,762

(22) Filed: Dec. 8, 2000

(51) Int. Cl. H02P 9/00

(52) U.S. Cl. 290/1 R

(57) ABSTRACT

When the load of a movable object is applied on to a platform of the invention it will create a counter force to the original point of application by means of specifically arranged mechanical devices. With such action the platform turns into an inclined surface to provide an automatic moving force for the movable object without requiring any outside power source except for the force of gravity.

### BACKGROUND OF THE INVENTION

Of all the forces in nature gravitation force is the least understood, and therefore the least utilized, by mankind, even though the influence of gravity is immensely immeasurable. Throughout the history of mankind the only application being utilized has been only in its one-directional aspect that could not be directly reversed or otherwise altered.

However, with an inventive arrangement of some mechanical devices already known to man, the limitation on the benefit of the gravitation force could somehow be broaden in its scope of application. For instance, as disclosed in the U.S. Pat. No. 6,019,055 by the present inventor, the load (gravitation force) on a floating platform could be diverted to various parts of the platform in order to create a more balanced force distribution by means of hydraulic and spring actions of the mechanical devices that were installed under the floating platform. Wherein under a normal circumstance this will only create a concentrated load on the platform and there will be no benefit derived from it whatsoever.

### SUMMARY OF THE INVENTION

It is therefore an objective of the present invention to provide a method and apparatus that will utilize the gravitation force to create a horizontal movement of a movable object.

The invention can be realized by redirecting the resultant of the one-directional (and therefore one point of application) vertical force nature of the gravity to various other purposefully-designated locations in order to create a counter force on the original point of application, by using mechanical devices that were specifically arranged to create such action.

Under an arrangement in accordance with this invention, when a mass of object is being set or applied on a hydraulically-operated platform of the invention the weight of the mass will start a chain reaction on the mechanical devices specifically-arranged under the platform; and this will create a lift or a counter force on the platform at the location that was being originally loaded. This action will turn the normally horizontal surface of the platform into an inclined plane. Therefore, if the mass of object is furnished with a set of wheels for mobility, it will be able to move freely down the sloping surface of the platform on its own accord and without the need for external force or any outside intervention.

An apparatus of the invention will be able to create an automatic and continuously mobile vehicle to provide an unending source of power for various applications, such as a power generator and the likes, if a series of this apparatus were arranged in a closed loop fashion.

### BRIEF DESCRIPTION OF THE DRAWINGS

FIG. 1 is a schematic view showing an apparatus in accordance with the present invention in its normal state.

FIG. 2 is a schematic view showing an apparatus in accordance with the present invention shown in FIG. 1 under a load bearing condition.

### DETAILED DESCRIPTION OF THE PREFERED EMBODIMENTS

Referring to the drawings, the illustrative embodiments of an apparatus for the automatic horizontal movement of a movable object utilizing gravitation force and the method of operation in accordance with the present invention will be explained in detail.

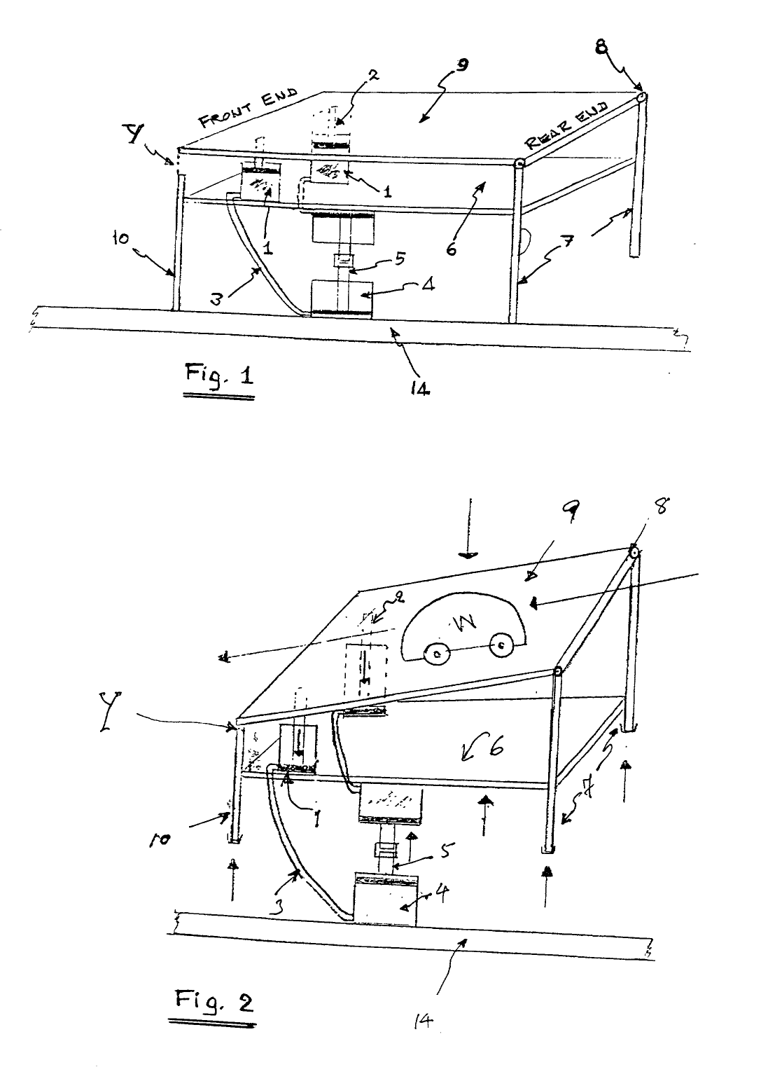

FIG. 1 shows an apparatus in accordance with the present invention in a normal and resting state, and comprising a flat surface platform 9 having a front end and a rear end. The rear end of platform 9 is attached by hinge 8 or any similar connector to rear legs 7, whereas the front end of platform 9 is overhanging above front legs 10 with a predetermined clearance Y. The degree of clearance Y will dictate the degree of inclination of platform 9 during the operation state. Both legs 7 and 10 stand on floor 14 and are movable in a vertical direction as shown by the arrows. Plate 6 is located below platform 9 and positively connected to legs 7, 10 in order to be movable in a vertical direction together.

Plate 6 is being supported by major, high capacity, hydraulic cylinder 4 and piston 5 resting on floor 14 as shown in the drawing. On top of plate 6 and under platform 9 near to the front end are a number of minor, low capacity, cylinders 1 and pistons 2 which are being hydraulically linked to major cylinder 4 and piston 5 by hydraulic line 3.

During an operation state as shown in FIG. 2, when a load W is applied on the surface of platform 9, platform 9 will force minor piston 2 to act on the major cylinder and piston 4, 5 by way of hydraulic line 3. With such action between the lower capacity minor cylinders and pistons 1, 2 and the higher capacity major cylinder and piston 4, 5, plate 6 and legs 7, 10 positively connected to it will be simultaneously raised to a predetermined level.

While the plate 6 and its legs 7, 10 are being forced to move to a higher level by the hydraulic action of major cylinder and piston, platform 9 will also be raised up by the same degree. However, since the minor cylinders and pistons 1, 2 attached to the underside of platform 9 are in a compressed state, the front end of platform 9 will be lowered until pistons 2 reach its stroke limit or as limited by the top end of front legs 10 (when the value of clearance Y reach zero). However, the rear end of platform 9 will retain its new height and begins to incline toward the front end from its rear hinged end, creating a sloping surface for an automatic movement of the wheeled object W toward the lower end of platform 9. And when platform 9 is no longer being subjected to the load W, all of the cylinders and pistons, both major and minor, will return to their original state as shown in FIG. 1.

It is to be noted that even though the embodiments of the present invention as illustrated and explained herewith contained the essence of the invention in its correct and concise state, it is still within the scope of the invention to make some adjustment and/or variation to them. For instance, the number of major cylinder and piston could be more than one units, and this also is applicable to the number of minor cylinders and pistons, as long as the total capacity of all the minor units is lower than that of the major unit.

1. A method for the utilization of a gravitation force in providing an inclined surface for an automatic movement of a movable object in a horizontal direction, including the diversion of a force to the pre-designated location(s) by means of hydraulic action of first hydraulic device and second hydraulic device installed under the platform, said method comprising:
in response to the gravitation force bearing on the platform, the first hydraulic device cause the upward movement of the second hydraulic device, and the upward movement of second hydraulic device, in turn, cause the rise in elevation of the platform creating an inclined surface.

2. A method as claimed in claim 1 wherein the first hydraulic device has a precedence over and dictating the operation of the second hydraulic device.

3. An apparatus for the utilization of gravitation force in providing an inclined surface for an automatic movement of a movable object in a horizontal direction, comprising a top platform with one end being connected to rear legs by a hinge, first hydraulic device of lesser capacity on the lower plate and positively connected to front and rear legs underneath said top platform at opposite end, and second hydraulic device of greater capacity on the floor and being hydraulically linked to said first hydraulic device on said lower plate.

4. An apparatus as claimed in claim 3 wherein the total capacity of first hydraulic device is less than the total capacity of second hydraulic device.
